(19) United States
(12) Patent Application Publication
(10) Pub. No.: US 2026/0362466 A1
(43) Pub. Date: Nov. 12, 2026

(54) LIQUID SCHEDULER FOR INTERFERENCE MITIGATION IN A RADIO ACCESS NETWORK AND METHODS FOR USE THEREWITH

(71) Applicant: ISRD Sp. z o.o., Piaseczno (PL)

(72) Inventors: Farinaz Kooshki, Piaseczno (PL); Robert Gdowski, Warsaw (PL); Slawomir Pietrzyk, Piaseczno (PL); Adam Dawid Flizikowski, Bydgoszcz (PL)

(73) Assignee: ISRD Sp. z o.o., Piaseczno (PL)

(21) Appl. No.: 19/670,155

(22) Filed: May 7, 2026

Related U.S. Application Data
(60) Provisional application No. 63/802,948, filed on May 9, 2025.

(51) Int. Cl. H04W 72/541; H04B 17/318; H04W 72/04

(52) U.S. Cl. CPC H04W 72/541; H04B 17/318; H04W 72/04

(57) ABSTRACT

A liquid scheduler of radio access network (RAN) operates by: receiving UE metrics corresponding to user equipment (UEs) served via radio units (RUs) of the RAN associated with the liquid scheduler; receiving UE metrics corresponding to other UEs of the RAN served by other radio units (RUs) not associated with the liquid scheduler; generating, via the liquid scheduler and based on the UE metrics corresponding to the UEs and the UE metrics corresponding the other UEs, UE-RB-RU, allocations of a plurality of RAN resource blocks (RB) to the RUs and the UEs associated with the liquid scheduler to mitigate interference between the UEs served by the RUs associated with the liquid scheduler and the other UEs served by the other RUs not associated with the liquid scheduler; and facilitating communication via the RAN between the UEs and the RUs associated with the liquid scheduler in accordance with the UE-RB-RU allocation.

### CROSS-REFERENCE TO RELATED APPLICATIONS

The present U.S. Utility patent application claims priority pursuant to 35 U.S.C. § 119(e) to U.S. Provisional Application No. 63/802,948, entitled “LIQUID SCHEDULER FOR INTERFERENCE MITIGATION IN A RADIO ACCESS NETWORK AND METHODS FOR USE THEREWITH”, filed May 9, 2025, which is hereby incorporated herein by reference in its entirety and made part of the present U.S. Utility Patent Application for all purposes.

### FIELD OF THE DISCLOSURE

The subject disclosure relates to implementation and control of wireless communication networks.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Reference will now be made to the accompanying drawings, which are not necessarily drawn to scale, and wherein:

FIG. 1A is a schematic/block diagram illustrating a non-limiting example of a communications network in accordance with various aspects described herein.

FIG. 1B is a schematic/block diagram illustrating a non-limiting example of liquid scheduler operations in accordance with various aspects described herein.

FIG. 1C presents schematic/block diagrams illustrating non-limiting examples of liquid scheduler operations in accordance with various aspects described herein.

FIG. 1D is a schematic/block diagram illustrating a non-limiting example of liquid scheduler operations in accordance with various aspects described herein.

FIG. 1E is a schematic/block diagram illustrating a non-limiting example of liquid scheduler operations in accordance with various aspects described herein.

FIG. 1F is a schematic/block diagram illustrating a non-limiting example of liquid scheduler operations in accordance with various aspects described herein.

FIG. 1G is a schematic/block diagram illustrating a non-limiting example of liquid scheduler operations in accordance with various aspects described herein.

FIG. 1H is a flow diagram illustrating a non-limiting example of a method in accordance with various aspects described herein.

FIG. 2 is a schematic/block diagram illustrating a non-limiting example of a network general controller in accordance with various aspects described herein.

FIG. 3A is a schematic/block diagram illustrating a non-limiting example of RAN-Sets and RB-Sets in accordance with various aspects described herein.

FIGS. 3B and 3C are schematic/block diagrams illustrating non-limiting examples of use cases in accordance with various aspects described herein.

FIGS. 4A and 4B are schematic/block diagrams illustrating non-limiting examples of UE-RBS-RANS allocations in accordance with various aspects described herein.

FIG. 5A is a schematic/flow diagram illustrating a non-limiting example of an architecture in accordance with various aspects described herein.

FIG. 5B is a schematic/block diagram illustrating a non-limiting example of communication between modules in accordance with various aspects described herein.

FIG. 5C is a schematic/block diagram illustrating a non-limiting example of a RAN stack component disaggregation in accordance with various aspects described herein.

FIG. 5D is a schematic/block diagram illustrating another non-limiting example of a RAN stack component disaggregation in accordance with various aspects described herein.

FIGS. 6A-6D are a schematic/block diagrams illustrating non-limiting examples of RAN stack instance cooperation in accordance with various aspects described herein.

### DETAILED DESCRIPTION

One or more examples/embodiments are now described with reference to the drawings, wherein like reference numerals are used to refer to like elements throughout. In the following description, for purposes of explanation, numerous details are set forth in order to provide a thorough understanding of the various examples. It is evident, however, that the various examples can be practiced without these details (and without applying to any particular networking environment or standard).

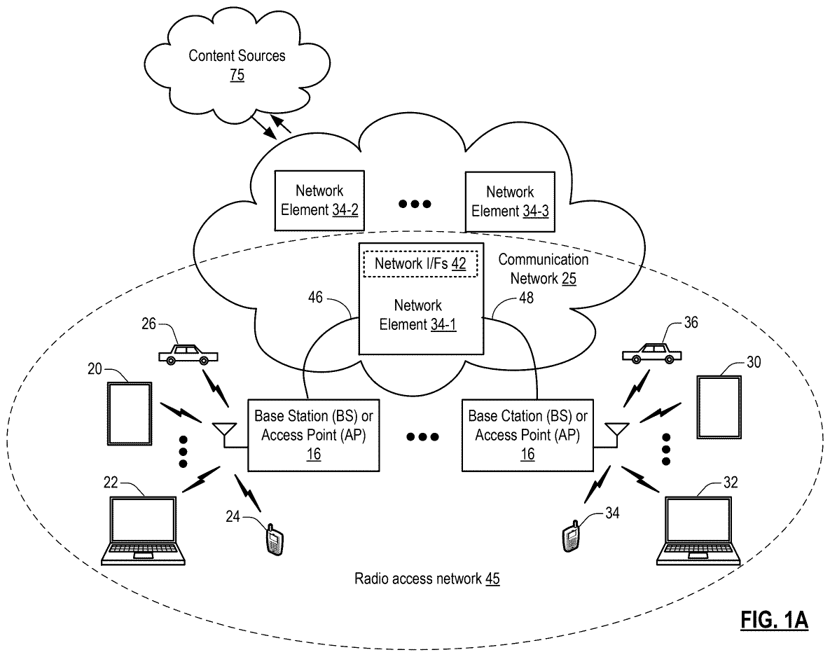

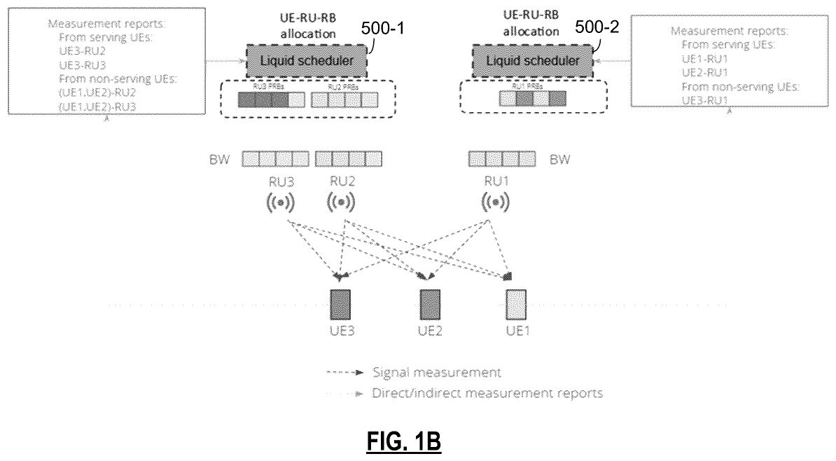

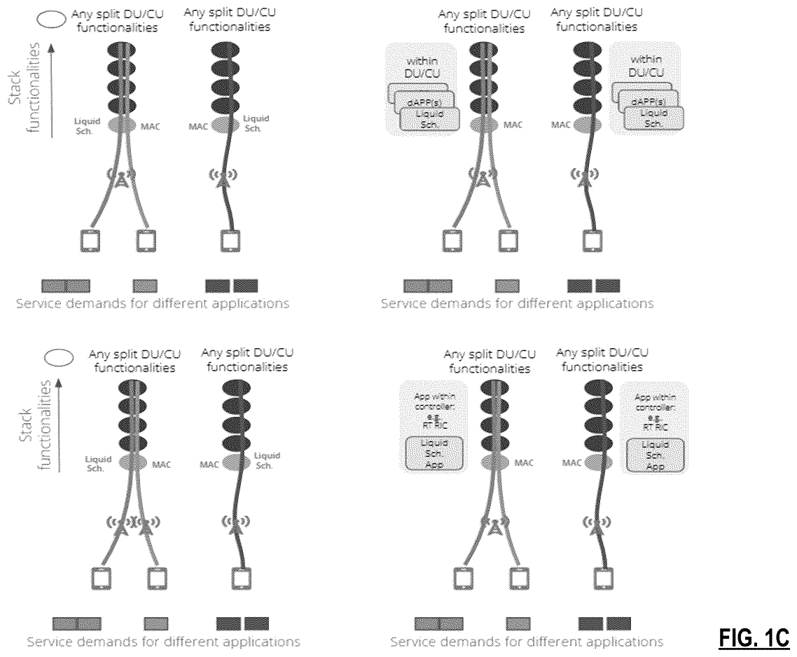

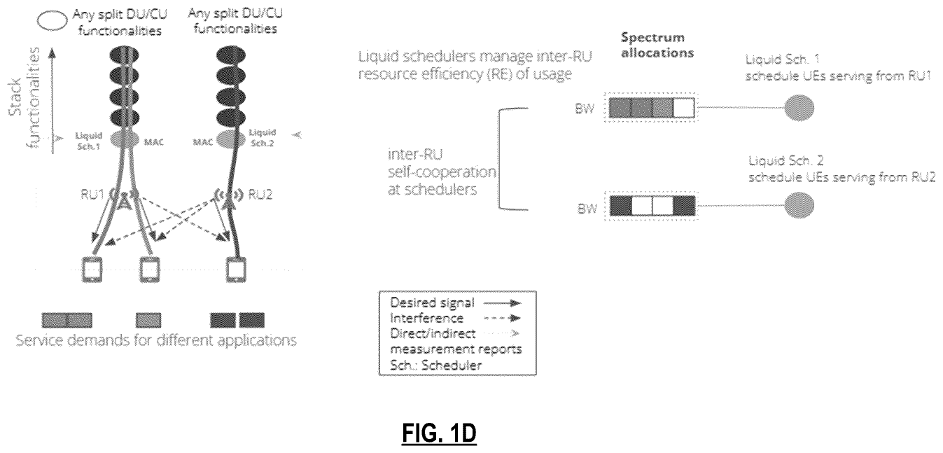

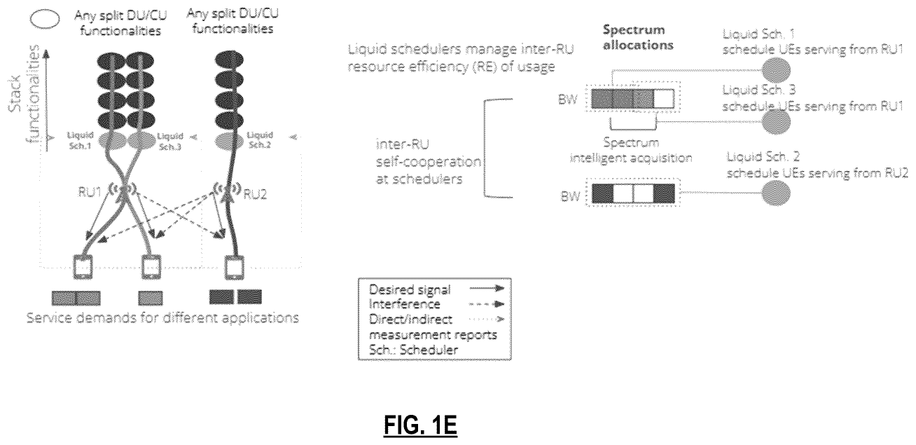

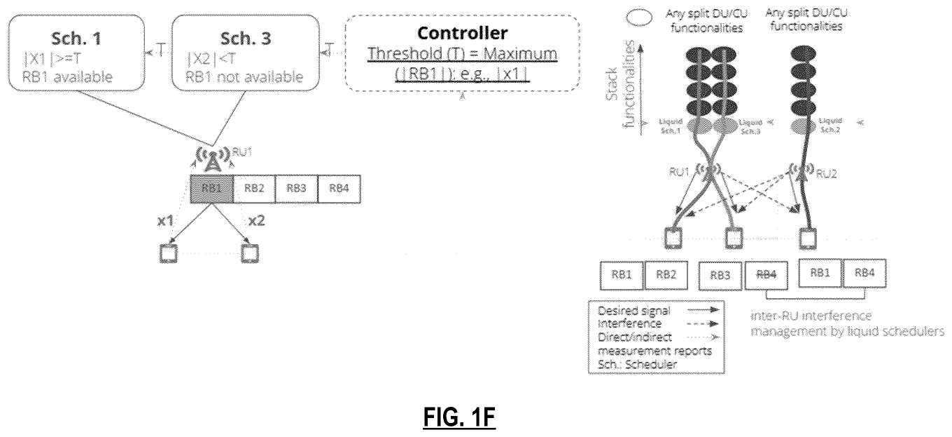

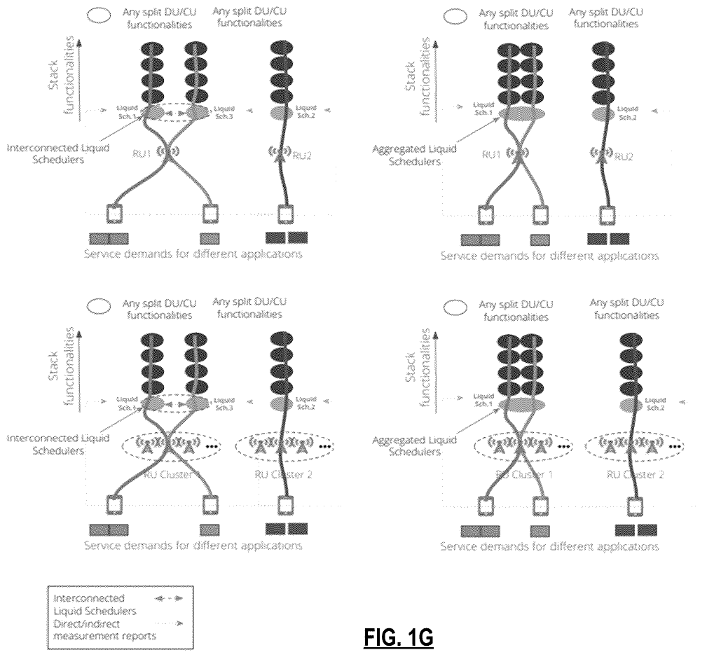

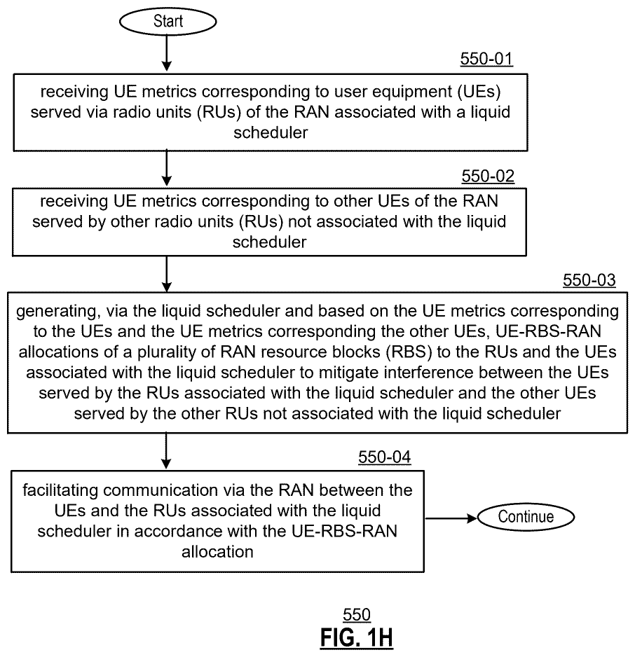

Referring now to FIG. 1A, a schematic/block diagram is shown illustrating an example, non-limiting example of a communications network 125, such as a core communications network or other wide area network in accordance with various aspects described herein. In particular, the communications network 125 includes a plurality of network elements 34, such as network elements 34-1, 34-2 and 34-3 that are shown.

In various examples, the network elements 34 are interconnected via transport links that can be wired, optical and/or wireless links that, for example, support encapsulated and encrypted transport. The network elements 34 can be implemented, for example, with the use of radio access network (RAN) controllers, RAN intelligent controllers (RIC) either non-real time, near real time or real time, programmable switches, edge servers, soft switches, network gateways, media distribution hubs, other routers, edge devices, switches, modules, capsules or network nodes and/or other network functions/devices and combinations thereof that themselves can be implemented via special purpose hardware, and/or via general purpose hardware computing programmed to perform their respective functions.

The communications network 125 operates to support communications including communications via the radio access network (RAN) 45. In operation, the communication network 125 transports data received from content sources 175 or other data content transport clients, and/or data conveying other communications between wireless communication devices. This data can include, e.g., audio, video, graphics, text or other media, applications control information, billing information, network management information and/or other data. The core communication network 25 (or more simply the core) also operates to manage access by the wireless communication devices, provides billing and network management and supports other network functions.

The wireless communication devices include tablets 20 and 30, laptops 22 and 32, mobile phones 24 and 34, vehicles 26 and 36 and/or other fixed or mobile communication devices. The wireless communications can include signals formatted in accordance with 3GPP, long term evolution (LTE) 4G, 5G, other orthogonal frequency division multiple access (OFDMA) protocols and/or other wireless signaling. These wireless communications devices can be referred to as client devices or user equipment (UEs), regardless of the particular standard used to communicate with these particular devices.

The wireless communication devices communicate with base station or access points 16 to receive services from the communication network 25. Typically, base stations are used for cellular telephone systems and like-type systems, while access points are typically used for in-home or in-building wireless networks. For direct connections (i.e., point-to-point communications), wireless communication devices communicate directly with the BS or AP 16 via an allocated channel, time slot, uplink/downlink (UL/DL) configurations and/or other physical resource block(s) (“PRB” or more simply “RB”) of a radio channel serviced by a plurality of radio units (RUs) that operate in conjunction with baseband processing to convert communications from the communications network 25 into wireless communications of the radio access network 45 and vice versa. Regardless of the particular type of communication system, each wireless communication device also includes, or is coupled to, a corresponding radio configured for wireless communications via the radio access network 45.

In the example shown, the network element 34-1 includes an edge server, radio access network general controller, module and/or other network element or elements having one or more network interface(s) (I/Fs) 42. The network interface(s) (I/Fs) 42 can include a wide area network interface for operating over one or more backhaul links with other network elements 34 operating to support data transport. In addition, the network interface(s) (I/Fs) 42 can support communications with other network elements 34 operating other portions of the radio access network 45. The network interfaces 42 can further support a plurality of other links 46 and 48, for upstream and downstream communication with a plurality of wireless communications devices over the radio access network 45 via base station (BS) or access points (AP) 16. For example, the network interfaces 42 can include a core network interface configured to communicate network communications with one or more network elements 34 of a core communication network, and a radio network interface configured to communicate communications BS or APs 16 of the radio access network 45. These interfaces 42 can operate via F1, E2, evolved packet core (EPC), next generation core (NGC), 5G core or via another network protocol or standard. The network element 34-1 can also include a cooperative radio resource manager or other radio resource manager that operates to support resource management of the radio access network 45 including load control and power control, and/or admission control, packet scheduling, hand-over control, and/or other user plane and control plane functions of a radio network controller/radio access network intelligent controller, etc.

In addition or in the alternative, the network element 34-1 and BS or AP 16 of the can be implemented in conjunction radio transceivers and baseband processing units in accordance with one or more deployment models e.g., Open RAN, disaggregated RAN, virtualized RAN, etc. and/or other standard that is based on interoperability and standardization of RAN elements and can include an interconnection standard for white-box hardware and open source software elements from different vendors to provide an architecture that integrates a modular base station software stack on off-the-shelf hardware which allows baseband and radio unit components from discrete suppliers to operate seamlessly together. In various examples, the network element 34-1 can include a packet processing function (PPF) which contains user-plane functions that are asynchronous to the Hybrid Automatic Repeat Request (HARQ) loop, and includes the Packet Data Convergence Protocol (PDCP) layer—such as encryption—and the multipath handling function for the dual connectivity anchor point and data scheduling and/or a radio control function (RCF) that handles load sharing among system areas and different radio technologies, as well as the use of policies to control the schedulers in the RPFs and PPFs. At the user and bearer level, the RCF can, for example, operate to negotiate QoS and other policies with other domains and is responsible for the associated service level agreement (SLA) enforcement in the RAN and/or to control the overall RAN performance relative to the service requirement, creates and manages analytics data, and the RAN self-organizing network (SON) functions.

While the BS or APs 16 are shown schematically as if having a single antenna, the BS or APs 16 (which can also be referred to as eNodeBs, eNBs, gNodeBs, gNBs, etc.) can each include a plurality of RUs (each with one or more antennas) that are supported by baseband processing via a combination of distributed units (DUs) and centralized units (CUs). In various examples, CUs, DUs and RUs communicate control plane and user plane signaling from the UEs to the core network. The CUs/DUs/RUs operate in conjunction with a radio access network protocol stack (that can be called more simply a “RAN stack” or “radio stack”) that can include, for example, a physical (PHY) layer, media access control (MAC) layer, radio link control (RLC) layer and one or more upper layers such as a Packet Data Convergence Protocol (PDCP) layer and/or a service data adaptation protocol (SDAP) layer, and/or other layers, etc. that also can be referred to as RAN stack components.

The network element 34-1 and BS or AP 16 can cooperate and operate in an architecture where the baseband processing via the DU/CU combination supports a plurality of RUs with, for example, multiple DUs attaching to a single CU and/or multiple RUs attaching to single DU and/or other combinations. Base station elements, including the DUs and CUs can be collocated in a BS or AP 16 with multiple RUs—but they do not have to be collocated. In addition or in the alternative, the CU alone or the CUs and DUs can be implemented in network element 34-1. In this case, element 34-1 can include a combination of 1:N DUs and/or 1 or more CUs with, for example, a single DU aggregating multiple RUs and/or a single CU aggregating multiple DUs. Other configurations of RUs, DUs and CUs are likewise possible. In various implementations, UEs can communicate with the RAN through either single or multiple links.

Mobile network data traffic is rapidly increasing with a high number of users having varying demands. Increased data demand requires more network capacity which necessitates densification. However, within dense areas, interference turns out to be a major concern as it degrades the network performance. To prevent performance degradation resulting from interference in the network, radio resource management (RRM) solutions use central schedulers for coordination of allocations. However, this approach can limit scalability because such schemes cannot scale with the number of UEs or cells, since both the amount of information to be conveyed and the algorithm complexity are infeasibly high. Distributed implementations of a cooperative paradigm can follow a “divide and conquer” approach by defining zones (e.g. grouping of multiple RUs/DUs/CUs and UEs), ensuring the schedulers can manage the resources within their zones. However, the initial issue of competition still remains at the borders of such zones. Prior scheduling mechanisms within zones follow the same approach characteristic of legacy competitive resource allocations—i.e., not coordinating decisions between zones and not caring about overall interference across them. This results in unmanaged inter-zone interference, decreasing network capacity. The other examples of zone-based approaches found in legacy networks are paging or location/tracking area updates. These examples exhibit the problem of signaling congestion or signaling overhead that may occur when many UEs simultaneously make their location updates.

In various examples, a resource management solution is presented that enables efficient resource utilization while managing interference (e.g., in a zone-less and/or independent manner) with a cooperation strategy via local “liquid schedulers”. Various embodiments introduce a parallel decision-making approach for radio resource allocations via such liquid schedulers—different from schedulers distributed across zones that follow sequential decision making heavily dependent on continuous communication among them that can introduce latency.

Consider the following example where RAN system comprises a liquid scheduler utilizing a processor configured based on operational instructions stored in a memory to perform operations that include:
receiving UE metrics corresponding to user equipment (UEs) served via radio units (RUs) of the RAN associated with the liquid scheduler;
receiving UE metrics corresponding to other UEs of the RAN served by other radio units (RUs) not associated with the liquid scheduler;
generating, via the liquid scheduler and based on the UE metrics corresponding to the UEs and the UE metrics corresponding the other UEs, UE-RB-RU, allocations of a plurality of RAN resource blocks (RB) to the RUs and the UEs associated with the liquid scheduler to mitigate interference between the UEs served by the RUs associated with the liquid scheduler and the other UEs served by the other RUs not associated with the liquid scheduler; and
facilitating communication via the RAN between the UEs and the RUs associated with the liquid scheduler in accordance with the UE-RB-RU allocation.

In addition or in the alternative to any of the foregoing, the UE metrics corresponding to other UEs are received from an other liquid scheduler of the RAN.

In addition or in the alternative to any of the foregoing, the UE metrics include signal power and channel state information corresponding to the other UEs.

In addition or in the alternative to any of the foregoing, the other liquid scheduler is associated with the other radio units that serve the other UEs.

In addition or in the alternative to any of the foregoing, the allocation of the plurality of RBS is further based on a resource efficiency.

In addition or in the alternative to any of the foregoing, the resource efficiency is based on an interference metric determined utilizing a function of received power of the other UEs served by the other RUs.

In addition or in the alternative to any of the foregoing, the liquid scheduler is implemented via one of a plurality of capsules that operate to cooperatively perform RAN stack operations.

In addition or in the alternative to any of the foregoing, the liquid scheduler is implemented via one of a plurality of capsules configured to perform the RAN stack operations corresponding to a media access control (MAC) layer.

In addition or in the alternative to any of the foregoing, the liquid scheduler is implemented via a liquidity controller capsule of the plurality of capsules.

In addition or in the alternative to any of the foregoing, the liquid scheduler is implemented via a liquid scheduler application of a RAN intelligent controller (RIC).

In addition or in the alternative to any of the foregoing, consider the following examples including additional functions and features that can furthermore be utilized in implementing such a liquid scheduler.

FIG. 1B shows the operation of two liquid schedulers 500-1 and 500-2 functioning independently—i.e. without necessity of sequential signaling exchange of radio resource usage. In the example shown, RU 1 is associated with liquid scheduler 500-2 and RUs 2 and 3 and associated with liquid scheduler 500-1. The independence between the two liquid schedulers is enabled via schedulings that utilize a metric which measures the impact of their own allocations on UEs. The available bandwidth at RU(s) is scheduled accounting for measurement reports from UEs both serving (i.e., associated with a particular liquid scheduler) and non-serving (i.e., not associated with this same liquid scheduler, but e.g., associated with another liquid scheduler). In the example shown, resources (RBs) are allocated to RUs with environmental awareness as driven by metrics associated with the UEs. This solution supports:
zone-less interference management relying on UE-centrism radio environment awareness (i.e., driven by UEs)—each scheduler can use signal measurements driven by non-serving UEs in addition to serving UEs. Therefore, schedulers can perform allocations that account for the collective interfering impact of allocations on the UEs at neighboring areas (non-serving UEs). UE measurements may include the signal power (e.g., RSRP, RSRQ/SINR/SNR) and also channel state information (e.g., CSI-RS and CSI-IM (interference level)) from serving and neighboring RUs. In this way, the “outgoing interference” of allocations at each scheduler can be accounted for.
decentralized scheduling relying on these metrics replaces inefficiency of legacy schedulers: the scheduling strategy at liquid scheduler transits from the legacy approach of “taking into account the received interference by serving UEs from neighboring RUs” into the approach of “taking into account the received interference by non-serving UEs, additionally”. The aim is to eliminate competition and network inefficiency, without the cost of additional coordinating entity. To enable schedulers ensuring efficient resource utilization, a metric is introduced called Resource Efficiency (RE) (e.g., see equation (1)) below.

In various examples, each liquid scheduler can manage the interference at serving but also the non-serving UEs considering the following example of Resource Efficiency (RE) metric—to do this there is no need of coordination among liquid schedulers 500-1 and 500-2:

$$R {E}_{m , k , n} = \frac{{f}_{1} ( {P}_{m , k , n} )}{{I}_{m , n}} \qquad ( 1 )$$

where P_{m,k,n} is the desired received power received by the user k from allocation of RB n at RU m, which can be obtained from measurements inputs from serving UEs shown in FIG. 1B. And f₁(P_{m,k,n}) represents a desired-signal metric determined by applying a first function, operation, or operator to the received-power information. The first function, operation, or operator may comprise, for example, a mathematical, statistical, filtering, weighting, aggregation, normalization, or scaling operation, including an average, median, percentile, weighted average, filtered value, aggregated value, maximum, minimum, or another operation of received power. This interference can be defined as (as example, but not limited to):

$${I}_{m , n} = {\sum }_{i = 1 , i \neq m}^{M} {f}_{2} ( {P}_{m , {U}_{i} , n} ) \qquad ( 2 )$$

where M is the total number of RUs and the quantity

f₂(Pₘ,U_{f},n)

represents an interference metric determined by applying a second function, operation, or operator to received-power information associated with signal radiating from RU m on RB n, which is considered as undesired signal received by users belonging to Uᵢ set (i.e., all kEUᵢ). Uᵢ is set of UEs associating with RU i≠m. The second function, operation, or operator may comprise, for example, a mathematical, statistical, filtering, weighting, aggregation, normalization, or scaling operation, including an average, median, percentile, weighted average, filtered value, aggregated value, maximum, minimum, or another operation of received power. The Interference I_{m,n} can be defined as a function of received power at non-serving UEs. Depending on the network configuration, computations could be based on RB groups (RBG). For the measurement reports, the network can constrain the number of RUs that UEs measure considering the cost of signaling and radio environment.

RE can be used as a metric (either alone or in addition to the existing key performance indices (KPIs), such as signal to noise and interference ratio (SINR) signal to noise ratio (SNR), received signal strength indicator (RSSI), reference signal received power (RSRP) cross-link interference (CLI) RSSI (e.g., CLI-RSSI), CLI sounding reference signals (SRS) RSRP (e.g., CLI-SRS-RSRP) and/or other metrics used in cooperative RAN architectures (e.g., cell-less RANs) to provide the resource utilization impact at the network. A higher value of RE can be perceived as corresponding to a higher constructive impact where the desired signals being optimized and receiving interfering signals at the neighboring areas are minimized. The liquid schedulers can use such network level metrics together with other signal power measurements to decentrally cooperate within the RAN for a common goal (i.e., network resource allocation efficiency and interference mitigation/management).

While the foregoing has provided an example of one possible methodology of collecting the exposed interference from neighboring zones, other methodologies could be employed (e.g., by applying coefficient factors or other weights and/or via other metrics and functions, etc.).

The various liquid schedulers disclosed herein can be applied to any type of RAN architecture to provide cooperative RRM. The liquid scheduler can address the resource allocation efficiency using measurements as weighting factors locally, for example, in ultra decentral deployments of RAN.

### Example 1: Deployment Options for the Liquid Schedulers

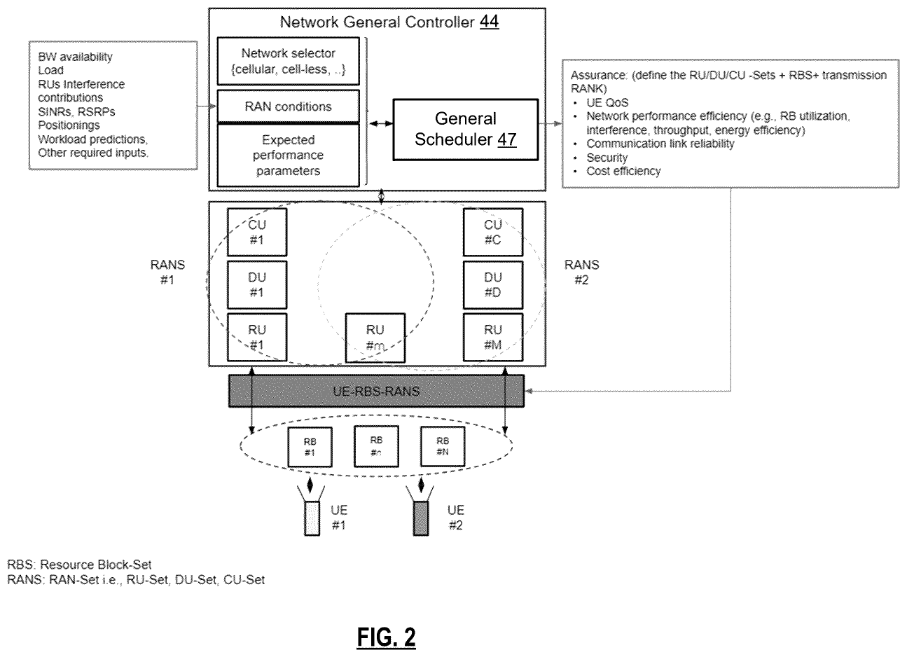

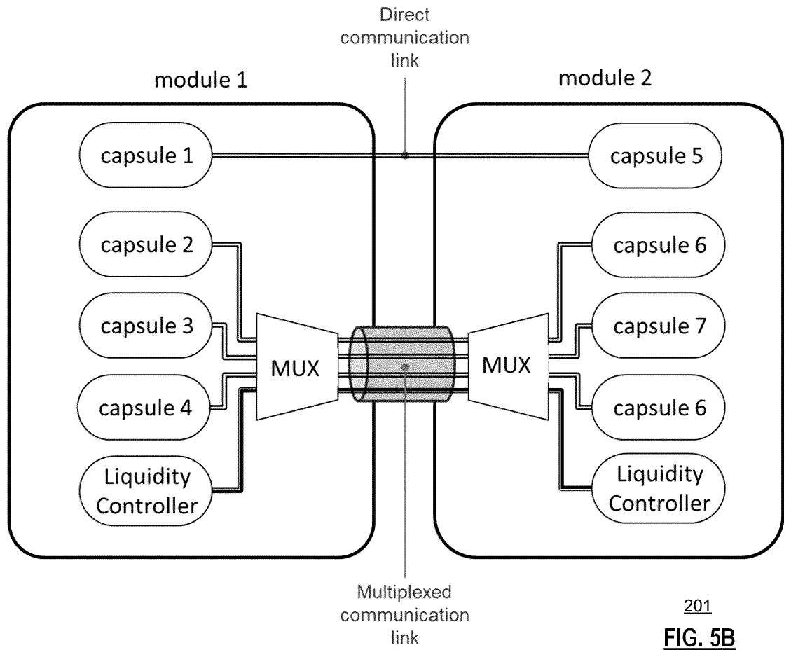

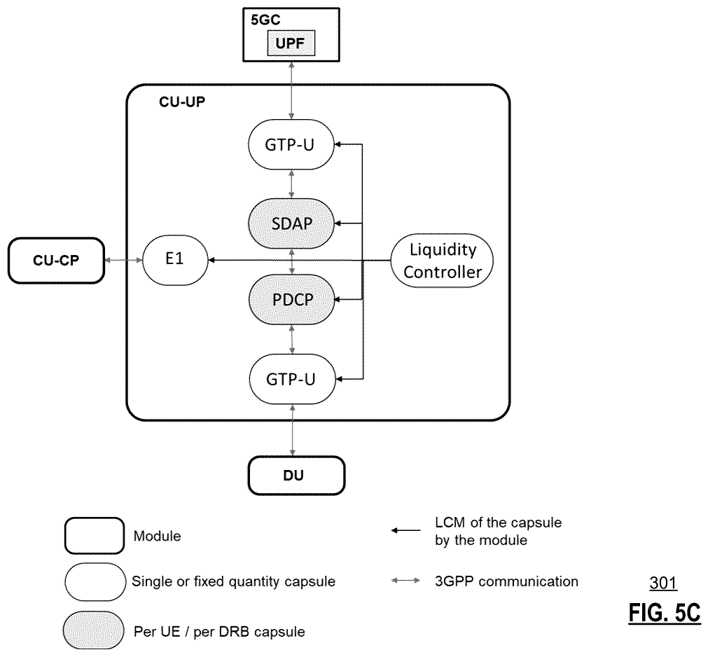

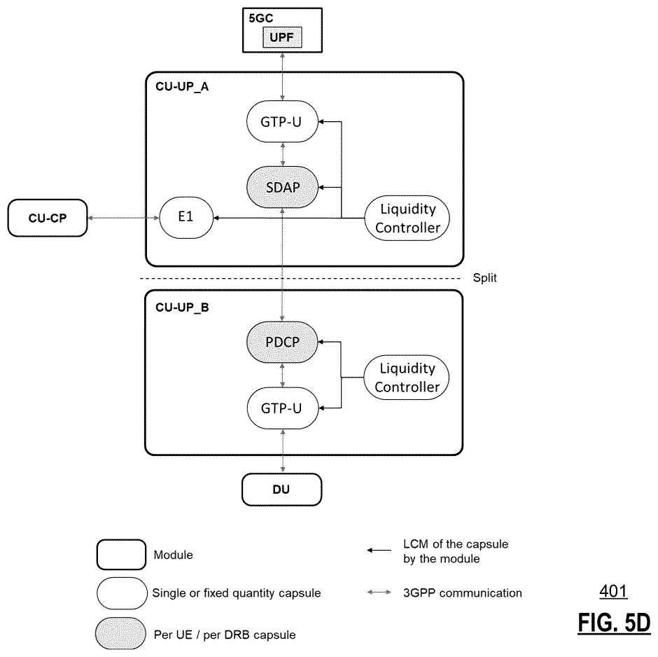

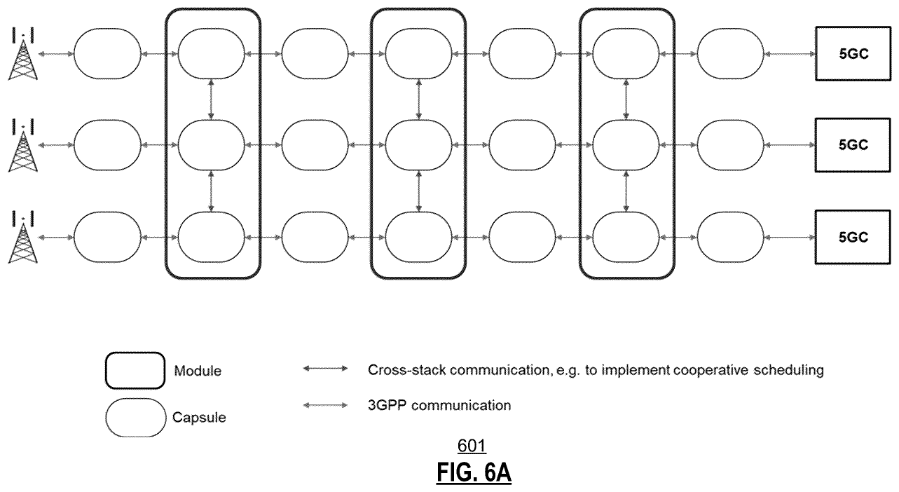

The baseline use case example is where the UEs served from any RU. The spectrum from each RU could be scheduled through the liquid schedulers, which can be deployed, for example, via a MAC scheduler irrespective of the number of RU's that DU can serve. In other examples, the liquid scheduler can be implemented via an application (e.g., dApp or an App) at a controller to make scheduling decisions that bypass the MAC. The liquid scheduler could also be deployed depending to the network architecture when possibly assisted by any type of controller such as: (a) a capsule, module and/or liquidity controller which will be described in further detail in conjunction with FIGS. 5A-5D, (b) a RAN network general controller/general scheduler which will be described in further detail in conjunction with FIGS. 2, 3A-3C and 4A and 4B, and/or (c) a real-time, near-real-time or non-real-time) ORAN RIC and/or other network function or element.

FIG. 1C shows the deployment example for four scenarios with liquid schedulers at MAC (left side option at figure with DU connecting to single RU or multiple RUs), or as application (right side options at figure as dApp shown at top option or application with a controller shown at bottom option). The commonality of all deployments is the scheduling strategy of liquid scheduler in which schedule resources in a decentrally-cooperative manner to increase network performance.

### Example 2: Liquid Schedulers to Schedule UEs from Different RUs

Various examples support a deployment of liquid schedulers serving UE(s) from different RUs. Such a deployment traditionally would be competitive across different RUs regarding allocations due to lack of a common coordinator. In contrast, liquid schedulers can enable resource utilization efficiency without the necessity of a common coordinator or a central scheduler on top, due to the RE metric relying on UE-centric radio environment awareness. FIG. 1D presents an example of a RAN architecture where liquid schedulers are implemented at the MAC layer and cooperatively schedule UEs serving different RUs for a reused spectrum. The liquid schedulers can perform independent resource allocations and for different RUs—being aware of estimated/predicted impacts of allocations on the neighboring areas.

### Example 3: Liquid Schedulers Schedule UEs from a Common RU

FIG. 1E shows an example where multiple liquid schedulers (e.g., deployed at separate MACs) schedule corresponding users (UE or applications or bearer) served by a common RU. In this case, each liquid scheduler can know which RBs (or RBGs) it can possibly schedule for its corresponding UE(s). This can happen in a way that schedulers do not conflict/overlap in allocating RBs—avoiding redundancies of unnecessary coordination (e.g. by means of dedicated signaling) to ease scalability and possible UE context migrations. In this fashion, the liquid controllers operate via a smart spectrum division that facilitates a scheduling that controls interfering allocations across different RUs (supported by RE) and can result in an efficient spectrum usage in the network.

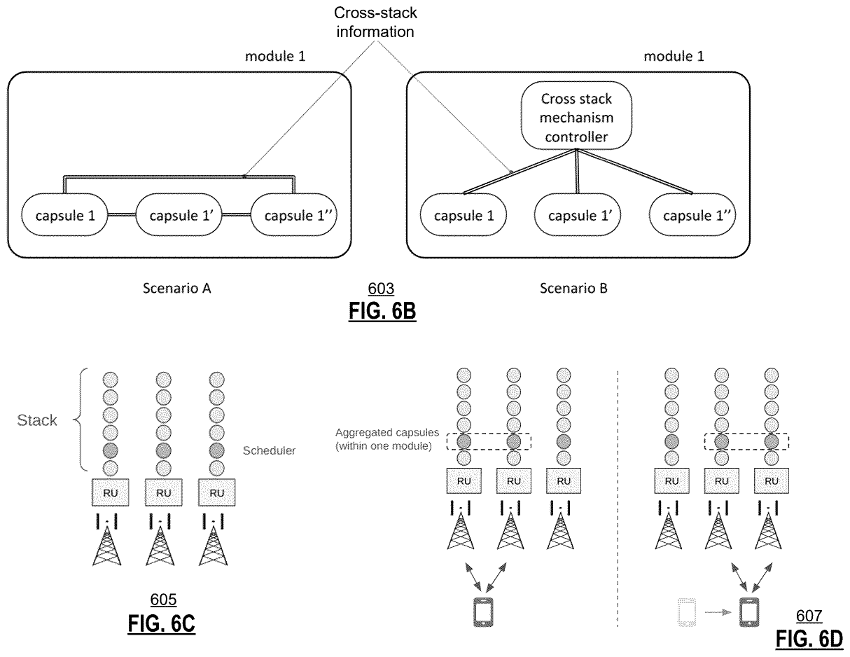

An efficient feasible solution is to aggregate the scheduling-capsules/modules (i.e., those schedulers that are serving UEs with RBs from common RU) and then treat them as a single scheduler that can be implemented via a functional aggregation of capsules as described in conjunction with FIGS. 6A-6D and/or enabled via direct communication between them to support collaboration. Both approaches take advantage of the co-location of the scheduler which would allow the use of algorithms for deterministic RB allocation. For example:
in case of an aggregated liquid scheduler, a single MAC scheduler could be used
in case of connected liquid schedulers, a cell-less (cooperative) scheduler could be used.

Both approaches can be combined. In this case, aggregation or interconnection of the liquid schedulers can be employed for schedulers serving one RU, while a liquid scheduler can be applied to scheduling activities across the RUs. The same mechanism can be used when RUs are clustered together. In this case the liquid scheduler approach can be used across RU clusters, see FIG. 1G.

However, in some use cases with respect to maintaining autonomy of liquid schedulers for the sake of ultra scalability and easy migration of UEs context, the liquid scheduler can be an applicable solution thanks to the inherently cooperative characteristic. FIG. 1E shows an example design for this use case. The measurements can include the signal strength and/or other measurements for competing users (UEs) on the same RB (or RBG) can be reported to neighboring schedulers (corresponding to competing UEs). In this case, competing UEs means those UEs (e.g., in neighboring zones) that can access the same spectrum from the common RU localization and tentative candidates that could be served. Each liquid scheduler can use this information to take part in RBs acquisition (e.g., like an auction, partitioning and/or other selection) in a self organized way. Furthermore, each liquid scheduler can have a corresponding/designated subset of RBs to schedule, without necessity of additional information exchange with other schedulers.

An example strategy presented in FIG. 1F which presents a spectrum division among multiple liquid schedulers scheduling UEs from a common RU. Each liquid scheduler receives measurement reports from its corresponding UEs and non-corresponding UEs (directly, or, e.g., via liquidity controller, RIC, etc.). In various examples, a liquidity controller can acquire RB (or RBG) if its corresponding UE has the highest rank. The measurements (including e.g., RSRP/SNR) could be shared with schedulers directly from UE reports in different ways (e.g., (but not limited to) direct UE feedbacks, dual connectivity, dAPP, through aid of a liquidity controller discussed further in FIGS. 5A-5B and/or other ways based on deployment scenario, as the schedulers sharing the same RU). The measurements can be shared with liquid schedulers through any controller. Accordingly, each particular scheduler can have a self-verification for acquisition of each RB (or RB group)—while all schedulers (for a common RU) can follow the similar strategy for acquisition; scheduler can allocate RB (or RBG) for its UE, if that UE is receiving stronger signal strength compared to other UEs. This information could be considered for decision making as a weighting factor in addition to other constraints based on the UEs demands and requirements. Accordingly, each particular liquid scheduler has subset(s) of RBs that could schedule for its designated UE(s). However, as liquid schedulers work cooperatively to enhance the network performance, a RB (or RBG) might be not allocated despite the scheduler can allocate it to the UE) in order to manage the network-level interference. This can be decided based on RE (resource Efficiency) metric and other scheduling strategies for inter-RU interference management existing at the scheduling policy of liquid scheduler.

FIG. 1H is a flow diagram illustrating a non-limiting example of a method 550 in accordance with various aspects described herein. In particular, a method is presented for use in conjunction with a RAN, one or more liquidity schedulers and/or any of the example architectures, examples, and/or embodiments described previously or in the sections that follow. Step 550-1 includes receiving UE metrics corresponding to user equipment (UEs) served via radio units (RUs) of the RAN associated with a liquid scheduler. Step 550-2 includes receiving UE metrics corresponding to other UEs of the RAN served by other radio units (RUs) not associated with the liquid scheduler. Step 550-3 includes generating, via the liquid scheduler and based on the UE metrics corresponding to the UEs and the UE metrics corresponding the other UEs, UE-RB-RU, allocations of a plurality of RAN resource blocks (RB) to the RUs and the UEs associated with the liquid scheduler to mitigate interference between the UEs served by the RUs associated with the liquid scheduler and the other UEs served by the other RUs not associated with the liquid scheduler. Step 550-4 includes facilitating communication via the RAN between the UEs and the RUs associated with the liquid scheduler in accordance with the UE-RB-RU allocation.

In addition or in the alternative to any of the foregoing, the UE metrics corresponding to other UEs are received from an other liquid scheduler of the RAN.

In addition or in the alternative to any of the foregoing, the UE metrics include signal power and channel state information corresponding to the other UEs.

In addition or in the alternative to any of the foregoing, the other liquid scheduler is associated with the other radio units that serve the other UEs.

In addition or in the alternative to any of the foregoing, the allocation of the plurality of RBS is further based on a resource efficiency.

In addition or in the alternative to any of the foregoing, the resource efficiency is based on an interference metric determined utilizing a function of received power of the other UEs served by the other RUs.

In addition or in the alternative to any of the foregoing, the liquid scheduler is implemented via one of a plurality of capsules that operate to cooperatively perform RAN stack operations.

In addition or in the alternative to any of the foregoing, the liquid scheduler is implemented via one of a plurality of capsules configured to perform the RAN stack operations corresponding to a media access control (MAC) layer.

In addition or in the alternative to any of the foregoing, the liquid scheduler is implemented via a liquidity controller capsule of the plurality of capsules.

In addition or in the alternative to any of the foregoing, the liquid scheduler is implemented via a liquid scheduler application of a RAN intelligent controller (RIC).

In addition or in the alternative to any of the foregoing and as previously discussed, the liquid scheduler can be implemented as part of and/or in conjunction with a network general controller/general scheduler, various examples of which are described in the sections that follow. In conjunction with these examples, “link reliability” can be referred to as the availability of redundant communication via (UE-RAN) paths. Link reliability can be affected by different factors such as lack of available radio resources, link blockages between the transmitter and receiver, low transmission quality and/or performance drops due to interference. Different approaches can be utilized to enhance link reliability. These include:
A bottom-up approach: Considering link failure probability from the context of finer granularity resources such as RBs for efficient RRM; and
A top-down approach: Providing redundancies assuring effectiveness of resource selections aimed at reliable communication.

Consider, for example, a shared-cell use case solution has been provided in O-RAN WG specifications (O-RAN.WG4.CUS, see e.g., https://specifications.o-ran.org/specifications). In a shared-cell model, multiple RUs operate as a single cell. Multiple RUs can transmit the same data stream over the reused portion of the bandwidth. Others have proposed solutions for UEs with hybrid switching between single serving cell and shared-cell and for dynamic grouping the RUs for a shared-cell that adds or removes a spectrum carrier to the group. However, the issue persists in decision making over use/re-use of resources in an uncoordinated way that can negatively influence the reliability of connections. In particular, a network might provide multiple links, but some of these links may not necessarily have a positive influence on the reliability assurance network-wide. Redundancies could be provided that fail to influence spectrum efficiency in each link. Although conflicts could be mitigated via higher level applications like conflict mitigation or through use of techniques such as beamforming. However, these are actions taken (possibly unnecessary or not optimal) following an inefficient approach of resource management. Therefore, earlier solutions failed to establish a top-down approach for a network with link reliability in a way that can be effectively integrated with a bottom-up finely detailed cooperative scheduling method.

Consider a RAN characterized by a RAN functionalities/modules such as RUs, DUs, CUs. Consider further a RAN-Set (or RANS) that represents a particular combination (e.g., a subset) of the available RAN functions/modules. In various examples, network element 34-1 includes a network general controller/scheduler 44 (or more simply a network general controller or “NGC”) that provides redundant data delivery to/from UEs by creating multiple links via combinations of necessary number of network functions determined as particular RANS and to the granularity of a determined RB-Set (RBS) via (UE-RBS-RANS) associations. This can result in the aggregation of multiple determined links (via the NGC) that increases the link reliability thanks to exploitation of combined macro (top-down) and micro level (bottom-up) diversity—as opposed to a one-dimensional diversity exploitation that relies on merely one or the other.

Various embodiments, examples and/or combinations improve on prior radio access networks by providing an effective and efficient network establishment and high level management of the communication via a NGC 44 that is configured to establish the network via a global selection and management of resources (including physical resources and/or spectrum). In various examples, the NGC configures the network based on expected services and entire available resources to:
create a necessary number of separate links in space to assure availability;
provide the redundancies of data transmission via effective selection of multiple links to assure a successful delivery; and
employ cooperative RRM for management of bandwidth (spectrum) allocation to provide reliable connection.
   Therefore, the efficient usage of the spectrum can be assured, while utilizing the effective selection of the transmission links.

In various examples, a network general controller, such as NGC 44 or other controller/scheduler, operates with a RAN such as RAN 45 or other RAN. The network general controller includes at least one processor and a memory configured to store operational instructions that, when executed by the at least one processor, cause the at least one processor to perform operations that include:
determining RAN conditions associated with the RAN, the RAN having a plurality of radio units (RUS), distributed units (DUs) and centralized units (CUs) that facilitate communication with user equipment (UEs) via a plurality of resource block sets (RBS);
determining a plurality of UE performance metrics corresponding to the UEs;
generating, based on the RAN conditions and based on the performance metrics corresponding to the UEs, selections of a plurality of RAN-Sets (RANS) from the plurality of RUs, DUs and CUs and a UE-RBS-RANS allocation that configures the communication with the UEs via redundant links based on the selections of the RANS and based on a multiplexed sequence of RBS of the plurality of RBS; and
facilitating, via at least one network interface, communication with the UEs in accordance with the UE-RBS-RANS allocation.

In addition or in the alternative to any of the foregoing, the UE performance metrics are determined by a session manager based on an expected quality of service.

In addition or in the alternative to any of the foregoing, the RAN conditions include one or more of: a bandwidth availability, load data, RU interference data, signal to noise and interference ratios, reference signal received powers, device positions, and/or workload predictions.

In addition or in the alternative to any of the foregoing, each of the plurality of RANS includes a proper subset of the plurality of RUs, DUs and CUs having an RU-Set, a DU-Set and a CU-Set.

In addition or in the alternative to any of the foregoing, two or more of plurality of RANS are intersecting subsets of the plurality of RUs, DUs and CUs.

In addition or in the alternative to any of the foregoing, the UE-RBS-RANS allocation is generated via a general scheduler that cooperatively associates each of the plurality of RANS with UEs based on spectrum level RBS allocation.

In addition or in the alternative to any of the foregoing, the general scheduler implements functionalities that are complementary to media access control (MAC) layer scheduling.

In addition or in the alternative to any of the foregoing, the general scheduler generates the UE-RBS-RANS allocation based on one or more of the metrics: UE quality of service, RB utilization, interference, throughput, energy efficiency, communication link reliability, security and/or cost efficiency.

In addition or in the alternative to any of the foregoing, the plurality of RANS facilitate the redundant links via multiple separate communication paths.

In addition or in the alternative to any of the foregoing, the redundant links convey redundant data via one or more of: Packet Data Convergence Protocol (PDCP) duplication, dual connectivity, copy and combine from an O-RAN shared-cell, and/or MIMO transmission via distributedly deployed antennas (e.g., distributed MIMO).

In addition or in the alternative to any of the foregoing, a network general controller can be used in an exemplary architecture employing a general scheduler and cooperative RRM with one or more of the following considerations:
The network could include a single architecture or multiple architectures (e.g., cellular, cell-less coexisting, etc.);
RANS components (e.g., RUs/DUs/CUs) can be sourced from any vendor independently;
Deployment could be: centralized, distributed, with use of SMO, non-RT RIC or near-RT RIC, cascade or Fronthaul Multiplexer (FHM) mode of shared-cell from O-RAN specification and/or provide other deployments; and
Communication diversity can be implemented between receivers and transmitters by providing redundant data via any technique like PDCP duplication, dual connectivity, copy and combine from shared-cell or incorporating any MIMO transmission and/or other processing techniques.

Further details regarding the network general controller 44 and methods for use therewith, including several alternatives and optional functions and/or features, are presented in conjunction with the discussion that follows.

In FIG. 2, a Network General Controller 44 is shown as a conceptual frame that enables selection of appropriate RAN components creating a necessary number of separated links (e.g., redundant links) with the purpose of optimizing reliability of transmission. It establishes a network including two RAN-Sets (RANS) composed of components (for each RANS) that can be sources from one or multiple vendors/stakeholders/tenants. In the example shown, RANS #1 includes RU #1-RU #m, DU #1, and CU #1 and RANS #2 includes RU #m-RU #M, DU #D, and CU #C. While not explicitly shown, other RAN components (including other RUs, DUs and/or CUs) could likewise be allocated to these two RANS-on either a dedicated or shared basis.

The network architecture can be selected by the NGC 44 as cellular, cell-less, VRAN, cloud RAN, or other network architecture. The NGC 44 can include a general scheduler 47 (irrespective of the way of deployment, that could be with use of e.g., xAPP or central or distributed scheduler) that generates UE-RBS-RANS allocations to provide necessary redundancy of data transmission via multiple paths. In this regard, it determines, and considers RAN conditions. Accordingly, the general scheduler 47 provides RAN component selection and resource allocation to assure user service satisfaction and network efficiency. In various examples, the general scheduler can be implemented as a module of NGC 44, however, in other examples, the NGC 44 and general scheduler 47 can be implemented as separate modules in communication with one another.

In addition or in the alternative to any of the foregoing, the general scheduler 47 can operate by performing one or more of the following operations:
Select: particular selection of the network elements, providing a particular path/cluster/number of network functions/vendors/tenants from UE to core.
Mix: enable sharing/centralization/cooperation/coexistent/aggregation of network functions/modules with possible overlap (e.g., set intersection) among particular sets.
Match: Assignment and allocation of selected and mixed sets to users corresponding to policies and objectives.

In various examples, RANS are established from one or more numbers of components including CU(s), DU(s), and RU(s). The general scheduler 47 associates each RANS with fine granularity at the spectrum level with UEs in a cooperative manner. The cooperativeness is applied for intra-RANS (among corresponding RUs) and inter-RANS.

In various examples, RANS operations of selecting, mixing and/or matching are aimed to ensure the effectiveness of enabling links-those components (e.g., RUs) that are meant to be incorporated for transmitting possibly redundant versions (i.e., copy) of data to/from) the corresponding end user UE—for successful reception (or transmission for uplink) of the data at UE (or from UE at uplink) through at least a link in case of outage of other link(s). The system applies exploration of macro diversity for improving reliability. In case there is no risk of link outage, the redundancies could be a means to respond to other needs such as capacity scaling rather than link reliability. Furthermore, the selection of UE-RBS-RANS, and the mixing and/or matching is in addition to scheduling of other resources (computing and physical resources, though it is not shown explicitly for simplicity).

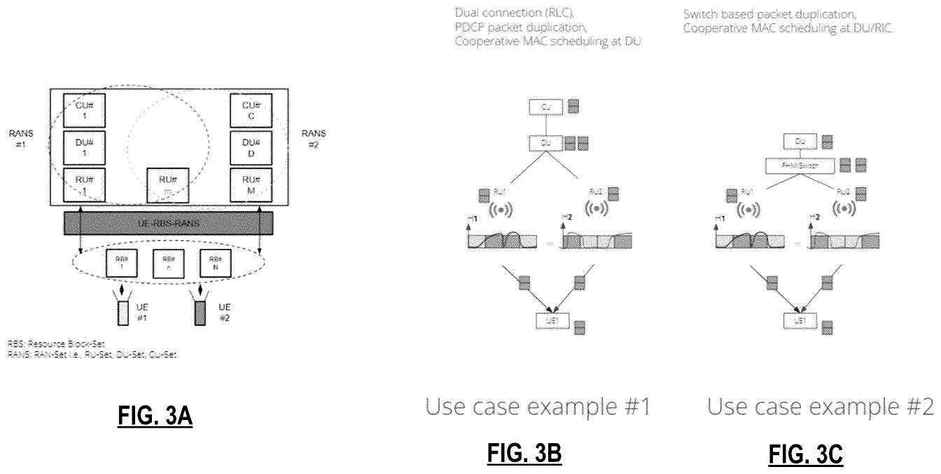

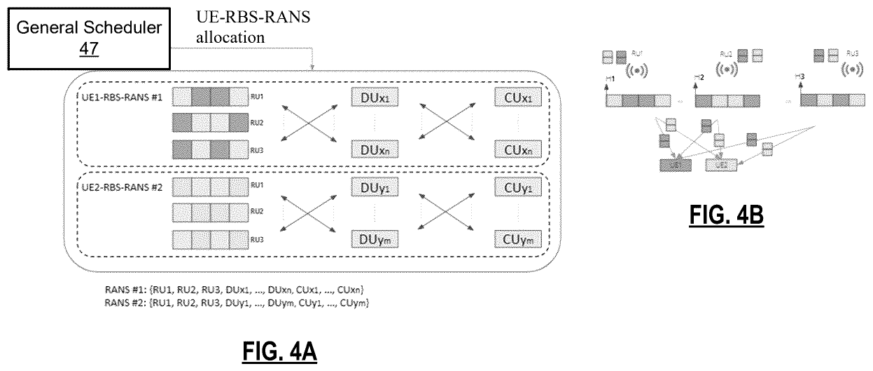

FIG. 3A presents an example that employs cooperative and fine granular scheduling of spectrum to enhance reliability via appropriate frequency diversity exploitation for varying channel conditions. The RANS are selected in similar fashion to FIG. 2. FIGS. 3B and 3C present two use cases and further present how RB spectrum allocations can be employed to provide redundant links to a particular UE. In particular, UE1 is provided with multiple copies of the signal transmitting from redundant spatially distributed links to combat instantaneous fading and/or other potential performance impacts. In these examples, the efficiency of transmission redundancy is backed up with cooperative and channel aware spectrum allocation.

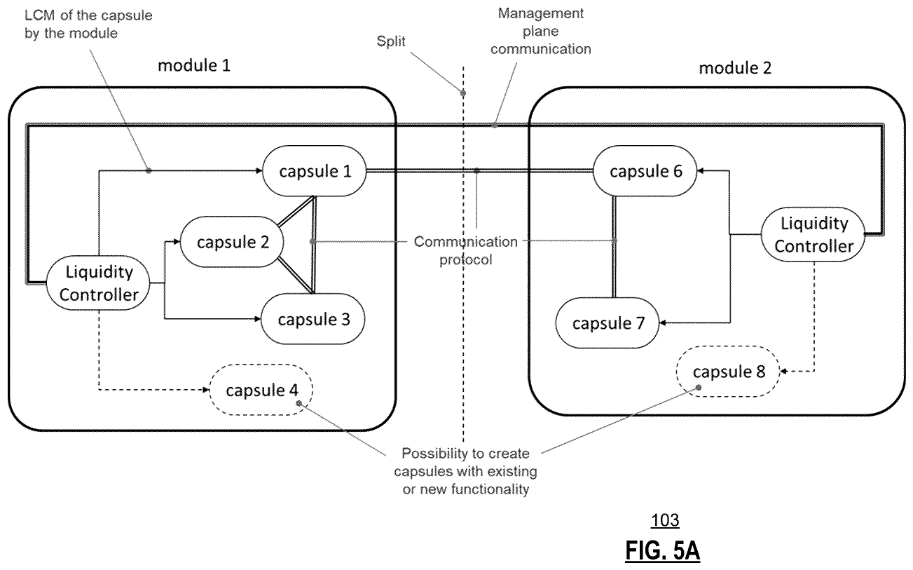

Turning now to FIG. 4A, a further example is presented where the general scheduler 47 allocates resources for each radio unit cooperatively to minimize the probability of link outage due to poor quality of inefficiently allocated spectrum. In the example shown, RANS #1 includes RU1-RU3, DUx1-DUxn, and CUx1-CUxn. RANS #2 includes RU1-RU3, DUy1-DUym, and CUy1-CUym. While not explicitly shown, other RAN components (including other RUs, DUs and/or CUs) could likewise be allocated to these two RANS-on either a dedicated or shared basis. Allocations are shown for UE1-RBS-RANS #1 and UE2-RBS-RANS #2. In particular, the RBS allocated to RANS #1 is shown via orange spectral blocks and the RBS allocated to RANS #2 is shown via yellow spectral blocks. In this fashion, redundant communication is enabled as shown in FIG. 4B.

In various examples, frequencies can be effectively and efficiently reused within each RANS. Consequently, the UEs are no longer obliged to be far from each other in space when they reuse the spectrum (possibly differently from RUs), thanks to the considered interference during scheduling. The scheduler allocates spectrum for each RU (from each particular RANS) cooperatively to the other RUs within the RANS and with other RANS. This enables performance stability in dense user conditions as well.

In various examples, cooperative scheduling exploits micro-diversity for efficient spectrum allocation to deliver the redundant copied data through multiple links (e.g., multiple RUs in space, or different antennas of the same RU distributed in space). Scheduling the bandwidth for the replicated packets could be employed through any deployment model like central scheduler, MAC scheduler at DU and deploying instances of DU, replication xAPP or any other deployment and implementation model.

In various examples, the general scheduler responsible for selecting, mixing and matching UE-RBS-RANS could be either provided with necessary measurements to make decisions for spectrum allocation (RB part) or it might take the RB allocations as input from a separate entity providing the network with cooperative spectrum allocations. Overall, RAN network functions are scheduled in a resource-efficient manner to provide end users with services through effectively reliable network connections.

While the foregoing has discussed allocation of RBs of RB-Sets corresponding to spectral portions such as spectral blocks, channels and/or other spectral resources—a network general controller could allocate RBs that could be used in both systems of a time division duplex (TDD) scheme with UL/DL separation in the time domain and/or a frequency division duplex (FDD) scheme with UL/DL separation in the frequency domain and/or other time-based systems-either alone or in conjunction with frequency-based systems.

In addition to or in alternative to any of the foregoing, the liquid scheduler can be implemented via a flexible SW architecture (e.g., via, in conjunction with and/or part of a liquidity controller, capsule, and/or module) that can be used in a software (SW) defined RAN and/or other configurations is disclosed herein in various embodiments, examples and/or combinations and further described in U.S. Pub. No. 2025-0088855 entitled “SECURITY IN A FLEXIBLE SOFTWARE-DEFINED RADIO ACCESS NETWORK ARCHITECTURE AND METHODS FOR USE THEREWITH”, the contents of which are incorporated herein by reference for any and all purposes. These examples provide the following advantages and/or improvements over traditional designs.
An architectural design for delivering highly-adaptable deployment structure, for real-time radio stack (that includes capsules, modules, liquidity controller and/or interfaces/adapters);
specific adapters/muxes (to assure seamless communication between modules);
a message exchange protocol that is independent of inter-capsule interface;s
an adaptable internal architecture that can repurpose itself and adjust its composition from a monolith (single module, single process, single machine) to highly-decomposed solution (distributed modules, distributed capsules, multiple nodes);
a design that supports a distributed RAN's protocol layer cooperation (e.g., cooperative scheduling);
a design that is suited to edge-cloud deployments and is capable of on-demand, online scaling;
a design that supports polymorphism of modules at run-time (module composition can be changed without engaging of the external orchestrator);
a Liquidity Controller (LC) that enables high degree of distribution for radio stacks
a design that can be applied also in non-RAN applications where the real-time, flexibility and adaptability of SW components are available
universal role of capsules for realtime communications (e.g., managed by an external operating system thread or other mechanism).
   Various examples and/or embodiments present a very pragmatic perspective of building blocks for a successful design of the RAN stacks, which meets the requirements of the future networks (e.g. IMT-2030). The SW components and the architectural foundations, described herein are the key building blocks that, on one hand, fit into the generic concept of service based architecture, but at the same time provide operational optimization of the monolith solution. One or more of these examples and/or embodiments facilitate:
building a scalable, flexible, robust and real-time radio stacks to form 5G and next generation networks,
deploying radio stack for 5G and beyond, to suite the multiple solutions for the edge-cloud continuum,
enabling the seamless functional splits for 5G (and beyond) network designs—i.e. the 3GPP functional splits should be considered as sample of the overarching set of options,
modifying the deployment of radio stack components (e.g. DU, CU, RU) prior or during operation of the stack without breaking the RAN function execution,
supporting cooperation between stack instances (and selected protocols) at various levels of the stack layers (e.g. direct cooperation between a number of stack instances), leading to support of multiple future updates and modernizations of RAN deployments (e.g. mesh, cell-free, etc.).
   The above mentioned features can be facilitated by optimized SW-design concepts of the radio stack, which allow a future radio stack to be fully portable, custom-based disaggregated and to an extent “fluid” with regards to the capability to adjust to resources available in the computing space.

Various examples and/or embodiments involve blocks for RAN stacks, among others, that provide suitability for situations where the computing resources in the edge undergo dynamic changes due to the emerging nature of the new applications that may rely more heavily on the support from AI/ML algorithms, might consume resources intensively, and can vary the amount of resources that might be expected. Various examples and/or embodiments allow compliant RAN networks to be ultra-flexible in where, when and how they are deployed and furthermore are compatible with dense deployments, the efficient use of computing resources, combined with the necessary access network architecture upgrades (e.g. cell-free) and efficient algorithms that support cooperative RRM, and can address the high expectations of future networks (e.g. 6G).

Various examples and/or embodiments involve a system and/or method for use with a radio access network having a plurality of capsules that operate in parallel to cooperatively perform RAN stack operations, each capsule utilizing a processor and a memory configured to perform a corresponding component of the RAN stack operations. The RAN stack operations can result in:
communicating backhaul communications with a core communication network;
communicating fronthaul communications with a plurality of radio units configured to engage in wireless communications with a plurality of user equipment (UEs) via a radio channel of a radio network;
converting, in accordance with a communication standard, received fronthaul communications from the plurality of radio units into backhaul communications transmitted to the communications network; and
converting, in accordance with the communication standard, received backhaul communications from the communications network into fronthaul communications transmitted to the plurality of radio units.

In addition or in the alternative to any of the foregoing, the operations further include: generating a UE to PRB to RU allocation that associates ones of a plurality of PRBs to selected ones of the plurality of UEs and selected ones of a plurality of RUs.

In addition or in the alternative to any of the foregoing, the corresponding components of the RAN stack operations performed by two or more plurality of capsules is implemented via a single thread.

In addition or in the alternative to any of the foregoing, a first subset of capsules is implemented by a first module under control of a first liquidity controller, wherein a second subset of capsules is implemented by a second module under control of a second liquidity controller, and wherein the first subset of capsules are mutually exclusive of the second subset of capsules.

In addition or in the alternative to any of the foregoing, the first liquidity controller controls life cycle management tasks of the first subset of capsules and the second liquidity controller controls life cycle management tasks of the second subset of capsules.

In addition or in the alternative to any of the foregoing, the first liquidity controller is configured to selectively add a new capsule to the first subset of capsules and wherein the first liquidity controller is further configured to selectively remove an existing capsule from the first subset of capsules.

In addition or in the alternative to any of the foregoing, multiplexers in the first module and the second module support logical links between two or more of the first subset of capsules and two or more of the second subset of capsules.

In addition or in the alternative to any of the foregoing, at least one first capsule of the first subset of capsules communicates directly with at least one second capsule of the second subset of capsules.

In addition or in the alternative to any of the foregoing, the first liquidity controller and the second liquidity controller cooperate to support migration of a first capsule from the first subset of capsules to the second subset of capsules.

In addition or in the alternative to any of the foregoing, the migration includes: recreating the first capsule as a new first capsule in the second module; moving a context to the new first capsule in the second module; and removing the first capsule from the first module.

In addition or in the alternative to any of the foregoing, the migration is performed during stack run-time.

In addition or in the alternative to any of the foregoing, the migration is triggered by a fault.

In addition or in the alternative to any of the foregoing, the migration is performed as part of a fault prevention.

In addition or in the alternative to any of the foregoing, the migration is performed as part of a security mechanism in response to a security attack on the RAN.

In addition or in the alternative to any of the foregoing, the plurality of capsules include a detection capsule configured to monitor network traffic and/or system hardware and to detect the security attack.

In addition or in the alternative to any of the foregoing, the plurality of capsules further include a mitigation capsule configured to mitigate the security attack via one or more protective actions.

In addition or in the alternative to any of the foregoing, a liquidity controller controls life cycle management tasks of the first subset of capsules.

In addition or in the alternative to any of the foregoing, the liquidity controller is configured to selectively add a new capsule to the first subset of capsules and wherein the liquidity controller is further configured to selectively remove an existing capsule from the first subset of capsules.

In addition or in the alternative to any of the foregoing, the plurality of capsules are configured to support slicing functionality to separately process different types of signals or different types of data corresponding to differing applications, wherein the differing applications include: 5G, media streaming, and/or gaming.

In addition or in the alternative to any of the foregoing, the plurality of capsules perform RAN stack operations corresponding to a plurality of RAN stacks.

In addition or in the alternative to any of the foregoing, the RAN includes a plurality if RUs, a subset of the plurality of capsules support cooperative scheduling across the plurality of RAN stacks.

In addition or in the alternative to any of the foregoing, the cooperative scheduling includes generating a UE to PRB to RU allocation that associates ones of a plurality of PRBs to selected ones of the plurality of UEs and selected ones of the plurality of RUs.

Further details regarding the operation of such a flexible SD-RAN SW architecture (e.g., utilizing capules), including several alternatives and optional functions and/or features, are presented in conjunction with the discussion that follows.

FIG. 5A is a schematic/flow diagram illustrating a non-limiting example of an architecture in accordance with various aspects described herein. An example SW architecture is presented where the overall RAN stack is divided into small functionality chunks called capsules. In various examples and/or embodiments, these capsules can have one or more of the following characteristics
a. Granularity of capsules can be arbitrary.
b. Capsules can be configured in the arbitrary way given the configuration options available for a given capsule,
c. A capsule can specify protocols it can use to communicate with other capsules for both
   the internal and external communication variants. In the internal communication variant capsules communicate with each other within a module (see next section) while external communication variant capsules communicate across modules (e.g. residing on different hosts). Internal communication can take benefits of fast in-process communication (e.g. shared memory) while external communication can take form of any communication protocol,
d. Capsules communicate via bi-directional ports and the means for communication in the capsule-to-capsule relation are defined ad-hoc (at UML level) by a port's protocol model
e. The following parameters are determined/optimized for each capsule: data object, number of ports, protocols used for communication outside the capsule
f. Capsule receives data objects, conforming to the port protocols, processes the data and (optionally) sends data objects, again, conforming to the port protocols.
g. Number of capsules can be related to the context of its operation (e.g. user terminal context). Such context can be subject to exchange between capsules residing in the same or different modules or host machines,
h. Some capsules can be created per UE, bearer or slice (e.g., PDCP protocol layer) while others can be common for the entire stack instance (e.g., MAC protocol layer), and
i. Capsules can be stateful, i.e. their operations are tightly coupled with the context, or stateless, i.e. their operations are decoupled with the context.

In various examples and/or embodiments, these capsules can be grouped together into entities called modules. In various examples and/or embodiments, modules can represent a service understood as independently deployable, loosely coupled, possibly fine grained software function. Modules can have one or more of the following capabilities:
a. A module can contain as little as one capsule or as many as all capsules into which particular software (e.g. radio stack) can be decomposed,
b. Modules control the life-cycle management (LCM) of all the capsules they contain (creating, configuring, running, reconfiguring, stopping and rerunning capsule instances) through a controller called a LC (Liquidity Controller),
c. The information or context needed for the LC to make particular action can come from multiple sources, e.g.: capsules, other LCs (from different modules), but also other, external sources of information or context,
d. LCs can communicate with each other via management plane communication which can be centralized or decentralized,
e. LC itself can be considered as a capsule,
f. LC enables standalone decision making related to dynamic adaptations of a module, without the need for interactions with the standard-based orchestrators (e.g. ETSI NFV), although, LC could naturally be considered as a main connection point for the external orchestrator, based on either (a) ETSI MANO architecture or alternatively (b) any container based architecture, e.g. Kubernetes, if the need arises to combine RAN stack adaptation and computing infrastructure management,
g. A module is capable of spawning and/or removing any capsule on demand, at run-time, it is a so-called module polymorphism. It is done through LC,
h. Modules, through the management plane communication of LC, are able to exchange user context. Together with point g) it enables capsule migration capability,
i. The communication between capsules across modules can be aggregated and serialized (resembling a multiplexer or MUX function) to simplify the cross-module communication (see e.g., FIG. 5B). An example use of such an approach could be the control plane communication,
j. Two communicating modules implement a RAN split. Split options can be defined beyond the traditional approach: horizontal (e.g. DU-CU) or vertical (CU-UP-CU-CP), or a combination of both (e.g. diagonal). Split design is only limited by the granularity of the capsules,
k. Connected modules together form a fully functional RAN protocol stack,
l. The module can be virtualized in a form of e.g. a virtual machine or a container.

In various examples and/or embodiments, adoption of the system of capsules in the construction and design of RAN stack enables the use of the following advantages:
Capsules support parallelism—the programming and testing activities can be optimized by reducing time for integration and speeding up the development/testing. In addition, with the parallelism of program execution, the RAN stack can utilize the CPU multithreading capability (coming from multiple cores per CPU) and hence utilize the proliferating multicore architectures,
Possibility to optimize the communication between capsules depending on the goals (e.g. URLLC) or deployment. E.g. capsules inside modules can use fast communication based on shared memory while communication between capsules across modules can take the form of any standard communication protocol,
Capsules contain and process data inside, they allow splitting processing easily between UL/DL, allow for scaling and provide safe operation,
Capsules expose message processing routines to the LC, which dynamically manages the actual processing within execution threads,
With capsules, parallelization of the processing inside stack becomes easily achievable when enhanced with additional enablers,
When aligned with the thread assigning mechanisms for the data transfer in DL and UL which provides a single thread (separately for DL and UL) to process functionalities of capsules in data-oriented manner (e.g. one thread per capsule group handling an incoming message), they can assure almost zero-cost of processing data inside RAN protocol stack. Data-oriented thread assignment mechanism built with the use of the capsule concept enables CPU optimization for different latency demands of the services based on the elastic thread assignment algorithms,
Capsules can be configured independently which can lead to capsule customization, depending on e.g. slice type, etc.
Depending on their role, capsules can be grouped per RAN, slice, UE or bearer which allows for designation-based capsule grouping. It can be beneficial in terms of capsule isolation and scaling. For example separate modules can be created for each new user. If a need arises, users can be easily migrated between modules in different physical hosts and grouped together in order to apply similar treatment or support similar QoS (e.g., delay).

In various examples and/or embodiments, the use of a capsule based, highly modular, scalable and polymorphic design that is further based on a Liquidity Controller provides the following advantages:
Flexible design for different scenarios:
   Given a capsule brings the atomic functionality piece of the RAN stack, the stack itself can be decomposed into any number of modules (containing at least one capsule or as many as all capsules). This feature provides following advantages
      The stack can be disaggregated to fit into any distribution of computing resources, therefore utilizing existing or available computing infrastructure to a greater extent,
      Capsules can be grouped together in various perspectives e.g., i) per user, ii) per slice iii) per bearer iv) per functionality (e.g. grouping schedulers from different stacks to perform cell-free scheduling). It gives the unprecedented possibility of functional isolation (similar functions grouped together for more effective collaboration service isolation (functions related to specific service (e.g., particular user) can be grouped together for security, reliability or scaling purpose) leading to higher portability, and simplified manageability,
      Modules representing stack services can be customized, given the specific functionality of the capsules included. This gives the possibility to create different variants of the same stack blocks fitting different scenarios. E.g. it can be easy to create multiple copies of CU user-plane: a) CU_U_basic (for standard deployment), b) CU_U_scalable (for enabling scalability of user-plane) and c) CU_U_LBO for enabling special routing inside the PDCP that allows rule-based traffic redirection for enabling the local breakout to local streaming server,
      flexible scaling-virtualized modules can be scaled with the use of existing orchestration tools. The capability to define and control the amount and type of capsules per module adds up to the scaling flexibility of RAN stack (e.g., fine grained or coarse grained).
   Capsules can be configured independently and arbitrarily. This can impose different behavior of different instances of the same capsule further improving the flexibility of the deployment. For example, a capsule containing PDCP functionality can be configured in AM (Acknowledged Mode) or UM (Unacknowledged Mode). Such customization can be extrapolated to whole modules (see, e.g., “Example 2” described below),
   Communication optimization possibility through adjusting communication means per capsule pair, e.g. high speed communication between capsules within a module (shared-memory) and any communication protocol used across modules. It enables adjustment of the RAN stack disaggregation towards target scenario (e.g. low latency),
Seamless operations and adjustment to changing requirements-module polymorphism allows RAN stack to change the module composition at run-time. This in turn can lead to a scenario where software can intentionally redistribute its functionalities across modules, across different computing nodes (together with user context migration). Mechanisms like this (whether distributed or centralized) can pave the way for functionality migration and fault management mechanisms which can work without direct intervention of the orchestrator and hence have a much faster reaction ensuring seamless user experience.

In addition or the alternative to any of the foregoing, capsules enable forming of the modules of arbitrary functionality. For example, the upper part of the protocol stack can be disaggregated into capsules that can further be aggregated into a module whose functionality is equivalent to CU-UP (see, e.g., FIG. 5C). This example implements whole protocols from the protocol stack (PDCP, SDAP), as well external interfaces (GTP-U, E1), however the granularity of the capsules can be higher where it is deemed suitable (e.g. PDCP can be divided into PDCP_High and PDCP_Low). Moreover, FIG. 5C also shows that the capsules related to 3GPP protocols can be instantiated separately for the user or bearer.

In addition, a stack functional component (e.g. CU-UP) can be either centralized or distributed between multiple modules (and also processing nodes)—see FIG. 5D for an example of a distributed deployment.

FIG. 6A depicts an example situation 601 in which instances of multiple radio stacks (i.e. one stack represents one cell) would need to exchange information (vertically) in a standardized (or non-standardized) way, in order to achieve some cross-stack improvements e.g. with respect to: efficiency, reliability, security or other perspectives. The proposed building-blocks of the SW-architecture described above, would be able to naturally support such cooperative behaviors with the use of: LC component, appropriately configured modules and a set of capsules.

A particular example would be a cooperative scheduling paradigm that would be useful in a situation where cooperation in resource allocation is assumed among multiple RU. In order to be successfully implemented, it would be desirable to includes a non-standard implementation of a scheduler that is able to control resources belonging to multiple radio units (RU), under control of a single (or multiple) DU. Examples of such techniques for cooperative scheduling are presented in U.S. Patent Publication 2022/0210794 entitled, COOPERATIVE RADIO RESOURCE SCHEDULING IN A WIRELESS COMMUNICATION NETWORK AND METHODS FOR USE THEREWITH, that was published on Jun. 30, 2022, the contents of which are incorporated by reference for any and all purposes. The mechanism utilizes low latency communication between RAN components which contain the scheduler. It can be realized by means of proposed SW architecture where relevant capsules responsible for scheduling are either located in one module (and benefit from in-process communication) or are located in modules interconnected with low latency links and/or being in the vicinity of each other. In various examples and/or embodiments, cooperative scheduling can be then achieved through the communication between relevant capsules which are part of different protocol stacks.

Additional examples and/or embodiments employing the communication of cross-stack information are presented further in conjunction with FIGS. 6B-6G and the description that follows.

These examples allow for customized orchestration of the 5G/6G network functions (e.g. RAN or Core) to improve performance through exchange of information within one or more selected stack layers (can be multiple at the same time) among modules or capsules. These examples address single and especially multiple-stakeholder (e.g. host neutral) 5G/6G deployments to allow their cooperation/aggregation. On various examples, the aim is to enable efficient and controllable horizontal exchange of information (parameters, metadata—e.g. context, learning hyper-parameters) for the networks following the existing and future evolution of functional splits. These examples refer to further evolution of the disaggregated mobile networks (e.g. beyond just the RU/DU/CU splits) towards more loosely-coupled system enhanced with custom interfaces. In particular the various examples are addressing the networks with increasing levels of function disaggregation, beyond the baseline splits of the 5G (e.g. RU, DU, CU). These examples build on top of the architectures with flexible splits and controlled granularity of functional modules packaging, that constitutes the radio stack.

Enabling cooperation among cells (or gNBs) in mobile network leads to a new paradigm which can be called cell-less or cell-free. The resulting use of a centralized resource control and allocation which leverages virtualization and disaggregation of radio stack (5G and beyond), has multiple benefits as it leads to improvements in capacity, energy efficiency and removes the need for handover. Such cooperation requires architectural extensions and enablers on the side of RAN stack that augment the existing specifications of 3GPP. This is achieved among others, by removing the baseline assumption underpinning the cellular networks operation—the competition in the resource allocation. Competition as opposed to cooperation assumes that resources are only “available within a cell” and cell has access to only local resources. The main assumption that enables breaking the barrier of cellular deployments with competitive resource allocation is to use all access points in a form of as a pool of resources. The allocable resources in such pool are: frequency, time and location (of access point or RU).

An example of functionality that already exists and is related to an extent with the distributed/aggregated functions, but as such is not built on top of the capsules-based disaggregated RAN, is the “LWA” (or also Dual Connectivity) and traffic steering (TS). The first and the latter deals with cooperation among two stacks where a) LWA is cooperation between LTE and WiFi stacks after aggregating its functionality into one node and b) TS is the loosely coupled cooperation between different RATs which are not collocated. In contrast to these earlier approaches, various example updates to disaggregated and virtualized RAN architecture that follow the architectural foundations behind cooperative resource allocation (i.e. cooperation at certain radio stack layer), can be generalized and applied to an arbitrary RAN stack protocol layer (e.g. PDCP, RLC, PHY as well as other mechanisms in MAC) or its atomic functions. The proposed modifications of RAN stack architecture address situations where the two or more RAN stacks (5G and beyond) can be set in a way to provide auxiliary communication means to the ones existing today in the 3GPP or ORAN. Various examples described herein focus on highly customizable intra-layer information exchange and cooperation (e.g. CU1-CU2-CUx, MAC1-MAC2-MACx, PTX1-PTX2-PTXn, where PTX denotes power control). Here the main goal is to leverage the capability to enable coexistence and cooperation between either:
1. capsules serving the same or similar function (e.g. scheduling) co-located in the same module, but containing different contexts (e.g. user/cell), or,
2. different stack modules (or functions) in the edge-cloud continuum.

In various examples of disaggregated and virtualized networks, RAN stack modules and capsules can be deployed in the common (i.e. shared) computing space, when the latency/performance requirements between stacks can be matched by appropriately orchestrating the workloads (e.g. in the densified environments with potentially numerous shared computing space). The above will be of particular application in a highly-disaggregated network deployments (ultra-dense networks, swarm-networks, etc.) because in such case there will be higher availability of compute nodes which are relatively “nearby”, where “proximity” will be mainly determined by the amount of latency/capacity of the links that connect such nodes.

In an example, cooperating capsules are co-located within the same module. Co-location of capsules serving different users, RUs, cells, etc. in one module is possible due to the polymorphic nature of the module (a module, with the use of Liquidity Controller, can create any functional capsule) as well as have the capability to send (e.g., to share and/or exchange) RAN related contexts across modules. With this capability it is possible to migrate a capsule from one module to another. Once capsules happen to be in one module they can utilize low-latency communication (e.g. via shared memory) for the purpose of cooperation.

In order to implement mechanisms benefiting from cross stack communication (e.g. cell-less paradigm), capsules can communicate directly with each other (in peer-to-peer fashion) or another capsule (a Cross Stack Mechanism Controller) can be created implementing mentioned mechanisms and at the same time communicating with capsules implementing particular protocol stack function. See, e.g., FIG. 6B that provides a diagram 603 of Capsule cooperation: Scenario A-capsules communicating in a Peer-to-Peer fashion; Scenario B-cooperation is controlled by a dedicated capsule “Cross-stack” mechanism controller). The latter capsule can represent a separate capsule or functional extension of the Liquidity Controller (LC).

As an alternative to the two above mentioned options, cooperating capsules within a module can be merged and become one capsule. In this case only the relevant context will be transferred between the modules without spawning new capsules at the module aggregating a function. If capsules are merged, the cross-stack mechanism can be implemented within the capsules or by means of another cross stack mechanism controller. The decision of which approach to choose depends strictly on the implementation process.

Both approaches can be seen as centralization of a particular function. With the difference that this centralization is not inherently embedded into the stack architecture but rather be organized spontaneously if such need arises. Indeed, capsule aggregation and distribution can be performed on demand targeting arbitrary capsules, at run time. It provides an opportunity to build dynamic mechanisms and algorithms which require changing underlying RAN infrastructure on demand. It should also be noted that reverse execution of aggregation approaches in the case of the originally centralized/cooperative approach can lead to distributed processing of originally combined/aggregated functions. In particular, various examples disclosed herein are “reversible” or “two-sided”.

### Cell-Less Example

Various examples, provide support of cell-less RRM by horizontal aggregation/disaggregation of capsules representing the same functionality-scheduler in particular. Aggregation can alleviate the latency which would be present if scheduler capsules would be separated. See e.g., FIG. 6C which provides a diagram 605 which includes independent schedulers for each RU.

Although cell-less architectures can be realized without capsules and their horizontal aggregation, to achieve dynamic clustering, horizontal function (scheduler) aggregation/disaggregation is needed as an enabler. Capsules implementing a scheduler can be dynamically aggregated/disaggregated to tackle the changing conditions (e.g. UE mobility) See e.g., FIG. 6D which presents a diagram 607 which employs dynamic horizontal aggregation and disaggregation (or more simply “reaggregation”) of a scheduler in response to changes in UE to PRB to RU allocation. In this solution, the denser the environment is (in terms of RUs and computing infrastructure) the better our solution works because it takes advantage of the vicinity of capsules whereabouts (if capsules are close it is easier to migrate them and merge). Therefore this solution scales well with the densification of the environment.

In a further example, different stack modules (and their internal stack related capsules) communicate in order to achieve the cooperation between stacks at the layer level. These new capabilities to arise require enabling each module of a RAN (e.g. CU, DU, RIC or a submodule thereof) to utilize a Liquidity Controller (e.g. micro-orchestrator entity) which will be performing a combined role of an orchestrator and a broker (with gateway option). Such an entity plays a major role in a module establishment and configuration. As such can execute a role similar to an ETSI-based of the “element manager”—where an element represents a radio stack “module”. But differs from other solutions because the controller enables an exchange of information (e.g. metrics, context, model parameters) with the other peers, i.e. controllers on the same (or another) level but inside other stack(s).

The various examples presented herein enable:
highly-customizable exchange of runtime information between stack layers, modules (or functions) in the “horizontal” dimension (i.e., across stacks). The proposed solution could as well be used to support “vertical” dimension (i.e., between layers of a single radio system).
fast exchange of arbitrary information (metrics, model parameters, KPIs, context, etc.) between any two or more peering modules (or functions) at horizontal layer (e.g. CU, MAC, scheduler, power control) which are co-hosted in the same compute space (e.g. edge server, or K8 pod)
exchange of information between modules (or functions) of different planes: control plane, data plane, management plane, knowledge (or cognitive) plane
the coordination of such exchange can be managed by various entities e.g. (i) directly by the LC components talking to each other, (ii) in cooperation with RIC (e.g. via dedicated xApp) (ii) under control of a service management and orchestration (SMO) element (e.g. via A1 policy), or (iii) in a less distributed way by introducing a new component i.e. the “Cross-stack Mechanism Controller” as shown in the FIG. 6B which can also be referred to as a Cross-Stack Manager or a Cross-stack manager controller). In the case of SMO here via A1 interface (or equivalent) the new horizontal-module coupling policies can be introduced.
   The above-mentioned improvements can be realized based on functional updates presented above, by adapting the functionalities of Liquidity Controller (LC) controller, and/or introducing the “Cross-stack Manager” controller (that can replace or augment selected functions of the Liquidity Controller and/or the Network General Controller discussed herein). Moreover the deployment of additional functions to control and manage the created “new horizontal clusters” can span across RIC and SMO in the ORAN architecture.

Furthermore, from the perspective of managing network stacks with tunable granularity and also composable function aggregation (on a compute node) and function distribution among various compute nodes, it becomes crucial to ensure proper control over what level of information (or data, measurements, etc.) is subject of exchange. Similarly the security assurance (i.e., authorization, authentical and accounting or “AAA”) is a consideration especially that the different stacks may belong to various operator (or networks, slices, etc.), where not necessarily all types of information can be feasible for exchange (e.g. exchanging trained model's parameter can be fine, while exchanging traffic profile of users might be too much detailed due to competitive markets). It is possible to activate a security control function (e.g. policy enforcement point) in order to assure security requirements when exchanging information between the module (or function) across the stacks.

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. The processing module, module, processing circuit, processing circuitry, and/or processing unit can further include one or more interface devices for communicating data, signals and/or other information between the components of the processing module and further for communicating with other devices. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more examples have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more examples are used herein to illustrate one or more aspects, one or more features, one or more concepts, and/or one or more examples. A physical example of an apparatus, an article of manufacture, a machine, and/or of a process may include one or more of the aspects, features, concepts, examples, etc. described with reference to one or more of the examples discussed herein. Further, from figure to figure, the examples may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contrary, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the examples. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in the form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more examples have been expressly described herein, other combinations of these features and functions are likewise possible. The present disclosure is not limited by the particular examples disclosed herein and expressly incorporates these other combinations.

What is claimed is:

1. A radio access network (RAN) system comprises:
a liquid scheduler utilizing a processor configured based on operational instructions stored in a memory to perform operations that include:
receiving UE metrics corresponding to user equipment (UEs) served via radio units (RUs) of the RAN associated with the liquid scheduler;
receiving UE metrics corresponding to other UEs of the RAN served by other radio units (RUs) not associated with the liquid scheduler;
generating, via the liquid scheduler and based on the UE metrics corresponding to the UEs and the UE metrics corresponding the other UEs, UE-RB-RU, allocations of a plurality of RAN resource blocks (RB) to the RUs and the UEs associated with the liquid scheduler to mitigate interference between the UEs served by the RUs associated with the liquid scheduler and the other UEs served by the other RUs not associated with the liquid scheduler; and
facilitating communication via the RAN between the UEs and the RUs associated with the liquid scheduler in accordance with the UE-RB-RU allocation.

2. The RAN system of claim 1, wherein the UE metrics corresponding to other UEs are received from an other liquid scheduler of the RAN.

3. The RAN system of claim 2, wherein the UE metrics include signal power and channel state information corresponding to the other UEs.

4. The RAN system of claim 2, wherein the other liquid scheduler is associated with the other radio units that serve the other UEs.

5. The RAN system of claim 1, wherein the allocation of the plurality of RBS is further based on a resource efficiency.

6. The RAN system of claim 5, wherein the resource efficiency is based on an interference metric determined utilizing a function of received power of the other UEs served by the other RUs.

7. The RAN system of claim 1, wherein the liquid scheduler is implemented via one of a plurality of capsules that operate to cooperatively perform RAN stack operations.

8. The RAN system of claim 7, wherein the liquid scheduler is implemented via one of a plurality of capsules configured to perform the RAN stack operations corresponding to a media access control (MAC) layer.

9. The RAN system of claim 7, wherein the liquid scheduler is implemented via a liquidity controller capsule of the plurality of capsules.

10. The RAN system of claim 1, wherein the liquid scheduler is implemented via a liquid scheduler application of a RAN intelligent controller (RIC).

11. A method for use with a radio access network (RAN), the method comprising:
receiving UE metrics corresponding to user equipment (UEs) served via radio units (RUs) of the RAN associated with a liquid scheduler;
receiving UE metrics corresponding to other UEs of the RAN served by other radio units (RUs) not associated with the liquid scheduler;
generating, via the liquid scheduler and based on the UE metrics corresponding to the UEs and the UE metrics corresponding the other UEs, UE-RB-RU, allocations of a plurality of RAN resource blocks (RB) to the RUs and the UEs associated with the liquid scheduler to mitigate interference between the UEs served by the RUs associated with the liquid scheduler and the other UEs served by the other RUs not associated with the liquid scheduler; and
facilitating communication via the RAN between the UEs and the RUs associated with the liquid scheduler in accordance with the UE-RB-RU allocation.

12. The method of claim 11, wherein the UE metrics corresponding to other UEs are received from an other liquid scheduler of the RAN.

13. The method of claim 12, wherein the UE metrics include signal power and channel state information corresponding to the other UEs.

14. The method of claim 12, wherein the other liquid scheduler is associated with the other radio units that serve the other UEs.

15. The method of claim 11, wherein the allocation of the plurality of RBS is further based on a resource efficiency.

16. The method of claim 15, wherein the resource efficiency is based on an interference metric determined utilizing a function of received power of the other UEs served by the other RUs.

17. The method of claim 11, wherein the liquid scheduler is implemented via one of a plurality of capsules that operate to cooperatively perform RAN stack operations.

18. The method of claim 17, wherein the liquid scheduler is implemented via one of a plurality of capsules configured to perform the RAN stack operations corresponding to a media access control (MAC) layer.

19. The method of claim 17, wherein the liquid scheduler is implemented via a liquidity controller capsule of the plurality of capsules.

20. The method of claim 11, wherein the liquid scheduler is implemented via a liquid scheduler application of a RAN intelligent controller (RIC).
